(19) United States
(12) Patent Application Publication
(10) Pub. No.: US 2009/0121481 A1
(43) Pub. Date: May 14, 2009

(54) AQUIFER FLUID USE IN A DOMESTIC OR INDUSTRIAL APPLICATION

(76) Inventor: William Riley, New York, NY (US)

Correspondence Address: FISH & RICHARDSON P.C., P.O. BOX 1022, MINNEAPOLIS, MN, 55440-1022, US

(21) Appl. No.: 11/938,550

(22) Filed: Nov. 12, 2007

(51) Int. Cl. F03B 13/06

(52) U.S. Cl. 290/43; 290/54; 290/52

(57) ABSTRACT

Fluid is moved from an aquifer to a higher elevation, and is used at the higher elevation for a domestic or industrial application. Subsequently, the fluid is allowed to return from the higher elevation to the aquifer. Kinetic energy of the fluid returning to the aquifer is converted into electrical energy.

### FIELD OF THE INVENTION

This disclosure relates to the use of aquifer fluid in connection with domestic or industrial applications.

### BACKGROUND

Various domestic and industrial applications use fluids, such as water. For example, water is used to cool or act as a heat sink for a variety of machinery and/or industrial processes. As another example, hot water is used to heat buildings and houses.

Aquifers generally contain large amounts of water, some of which may contain considerable heat. Aquifers are largely subterranean, making the fluid in an aquifer relatively difficult and costly to access.

### SUMMARY

In one aspect, a method includes moving fluid from an aquifer to a higher elevation and using the fluid at the higher elevation for a domestic or industrial application. After using the fluid for the domestic or industrial application the fluid is allowed to return from the higher elevation to the aquifer. Kinetic energy of the returning fluid is converted into electrical energy.

In some implementations, converting the kinetic energy of the returning fluid includes directing the fluid through a turbine-generator. The turbine-generator may be located a sufficient height above the aquifer's fluid level that the fluid returning to the aquifer can flow substantially freely through the turbine-generator.

According to certain embodiments, moving the fluid from the aquifer to the higher elevation includes using a submersible pump that is located beneath the aquifer's fluid level to pump the fluid to the higher elevation. At the higher elevation, the fluid can be used, for example, as a source of heat or as a heat sink.

In a typical implementation, the fluid is moved from the aquifer to the higher elevation through a first fluid communication channel and returned to the aquifer through a second fluid communication channel.

In some implementations, the fluid enters a collection area at the higher elevation before returning to the aquifer. In some implementations, the method includes using electrical energy from an electrical supply system to move the fluid from the aquifer to the higher elevation and supplying electrical energy to the electrical supply system from the turbine-generator. In such implementations, the method may include monitoring demand on the electrical supply system. If the monitored demand exceeds a predetermined first value, the fluid may be allowed to flow from the higher elevation (e.g., from the collection area) to the aquifer. Alternatively, if the monitored demand is less than a predetermined second value, at least some of the fluid may be prevented from exiting the collection area to return to the aquifer.

According to another aspect, a system includes an aquifer, a pump to move fluid from the aquifer to a higher elevation, means at the higher elevation to use the moved fluid for a domestic or industrial purpose and a turbine-generator to convert kinetic energy of fluid that is returned to the aquifer substantially under the influence of gravity into electrical energy.

The turbine-generator may be located a sufficient height above the aquifer's fluid level that the fluid returning to the aquifer can flow substantially freely through the turbine-generator. In some implementations, the system includes a first fluid communication channel between the aquifer and the higher elevation, through which the pump can move fluid and a second fluid communication channel between the aquifer and the higher elevation to facilitate the fluid's return to the aquifer from the higher elevation.

In certain implementations, the portion of the second fluid communication channel that extends between the turbine-generator and the aquifer includes multiple paths that terminate at different places in the aquifer.

The pump typically is a submersible pump and is located beneath the aquifer's fluid level. The means to use the moved fluid for a domestic or industrial purpose can be, for example, a heat exchanger, adapted to either draw heat from or deposit heat to the aquifer fluid.

Some implementations include a fluid collection area at the higher elevation where the fluid can be collected and temporarily stored before returning to the aquifer. In some instances, the system includes an electrical supply system to supply energy to move the fluid from the aquifer to the higher elevation. In those instances, the turbine-generator may supply electrical energy to the electrical supply system. A control system can be provided to monitor demand on the electrical supply system. If the monitored demand exceeds a predetermined first value, the control system allows fluid to flow from the collection area to the aquifer. Alternatively, if the monitored demand is less than a predetermined second value, the control system can prevent at least some of the fluid from exiting the collection area and returning to the aquifer.

In yet another aspect, a method includes monitoring demand on an electrical supply system. If the monitored demand exceeds a predetermined first value, fluid is allowed to flow substantially under the influence of gravity from an elevation above an aquifer into the aquifer and converting kinetic energy associated with the flowing fluid into electrical energy. If the monitored demand drops below a predetermined second value, fluid is moved from the aquifer to the higher elevation. When the fluid is at or near the elevation above the aquifer, it can be used for various domestic or industrial applications.

In some implementations, converting the kinetic energy of the flowing fluid into electrical energy includes causing the fluid to flow through a turbine-generator, which may be located a sufficient distance above the second aquifer's fluid line that the fluid flows freely through the turbine-generator.

In still another aspect, a system includes a first aquifer, a second aquifer, one or more fluid communication channels that facilitate fluid flow between the first and second aquifers, a turbine-generator to convert kinetic energy of fluid flowing from the first aquifer to the second aquifer through one or more of the fluid communication channels into electrical energy, a pump to move fluid from the second aquifer to the first aquifer and a heat exchanger to remove or deposit heat from or to the fluid as the fluid is moved from the second aquifer to the first aquifer in connection with a domestic or industrial application. The turbine-generator may be positioned a sufficient distance above the second aquifer that the fluid flowing from the first aquifer to the second aquifer can flow freely through the turbine-generator.

In some implementations, one or more of the following advantages are present.

For example, abundant supplies of fluid (from one or more aquifers) may be accessed and used for a variety of domestic and industrial processes in a cost-effective manner.

Additionally, hydroelectric pumped-storage facilities may be created at a relatively low cost. Accordingly, the resulting pumped-storage hydroelectric energy may be provided to end users at a more affordable rate. Peak electrical demand required of an electrical power system may be satisfied in a cost-efficient manner.

Natural resources may be utilized to store and supply energy in a cost-efficient manner. Those resources may be utilized additionally in connection with one or more domestic or industrial applications.

Other features and advantages will be apparent from the description and drawings, and from the claims.

### BRIEF DESCRIPTION OF THE DRAWINGS

FIG. 1 is a cross-sectional view showing one implementation of a system for accessing aquifer fluid for use in connection with domestic or industrial applications.

FIG. 2 is a cross-sectional view showing another implementation of a system for accessing aquifer fluid for use in connection with domestic or industrial applications.

FIG. 3 is a cross-sectional view showing yet another implementation of a system for accessing aquifer fluid for use in connection with domestic or industrial applications.

### DETAILED DESCRIPTION

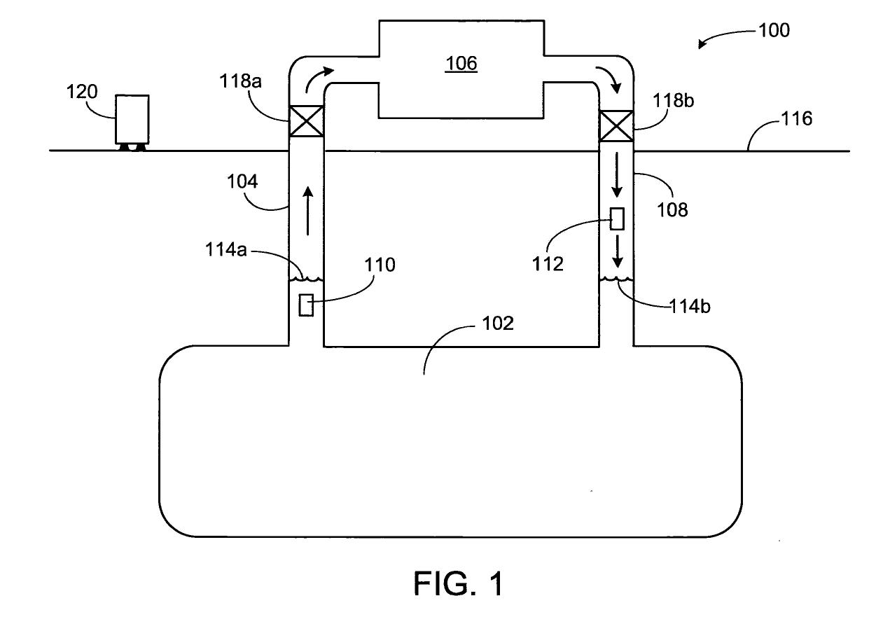

The system 100 of FIG. 1 enables fluid to be accessed from a subterranean aquifer 102 and used in connection with a domestic or industrial application in a cost-efficient manner.

A first fluid communication channel 104 extends from the aquifer 102 to a heat exchanger 106 at an elevation above the aquifer 102. In the illustrated implementation, the heat exchanger is located just above the earth's surface 116. A pump 110 is provided inside the first fluid communication channel 104 to move fluid from the aquifer 102 to the heat exchanger 106. Although the illustrated implementation indicates that the aquifer fluid is delivered to a heat exchanger 106, in other implementations, the aquifer fluid can be delivered to any means for using the aquifer fluid in a domestic or industrial application. Such means can include components or groups of components such as heating system components, air conditioning and refrigeration system components, heat exchangers to cool domestic or industrial equipment and any application that is not likely to compromise the quality of the water returning to the aquifer.

A second fluid communication channel 108 extends from the heat exchanger 106 to the aquifer 102. The second fluid communication channel 108 is adapted to accommodate fluid flow from the heat exchanger 106 to the aquifer 102 substantially under the influence of gravity. A turbine-generator 112 is provided inside the second fluid communication channel 108 to convert kinetic energy of the flowing fluid into electrical energy. The electrical energy generated by the turbine-generator 112 can at least partially offset the energy used by the pump 110 to move fluid from the aquifer 102 to the heat exchanger 106.

In some implementations, it is desirable to position the turbine-generator 112 as low as possible in the second fluid communication channel 108. That minimum height may vary depending on a variety of factors including, for example, the aquifer's permeability and saturation level and the rate of fluid flow that the second fluid communication channel 108 can accommodate.

If the aquifer's permeability were low, for example, then it may be desirable to position the turbine-generator 112 higher in the second fluid communication channel 108. That is because of the possibility that the bottom of the second fluid communication channel 108 would fill up with fluid if the rate of fluid flow in the channel 108 exceeds the aquifer's ability to absorb fluid. If the fluid level were to rise to the turbine-generator 112, fluid flow through that turbine-generator would be compromised.

An aquifer's saturation level can affect its ability to absorb additional fluid. Accordingly, if the aquifer's saturation level were particularly high (e.g., if the aquifer were highly saturated), then it may be desirable to position the turbine-generator 112 higher in the second fluid communication channel 108. This can help avoid the situation in which fluid accumulation in the second communication channel results in a rise in the fluid level that reaches the turbine-generator 112 and compromises fluid flow through the turbine-generator 112.

Typically, the pump 110 is a submersible pump and, in the illustrated implementation, it is located below the aquifer's fluid level. It is generally desirable that the pump 110 be located as low as possible, and preferably well below, the aquifer's fluid level. Locating the pump 110 as low as possible helps to ensure that a positive pressure exists at the pump's inlet.

If the pump 110 itself is not located below the aquifer's fluid level 114b, then the pump's suction line should extend below, and preferably well below, the fluid level 114b. Extending the pump's suction line well below the fluid level 114b helps to ensure that the pump 110 will be able to continue moving fluid out of the aquifer 102 even if only a small amount of fluid is present.

If the pump 110 is intended to operate from a position above the aquifer's fluid level 114b (under any operating conditions), it may include a means for priming (not shown). In general, the means for priming may be adapted to substantially fill the pump-turbine's casing with fluid prior to it starting to operate. In some implementations, the priming means is a vacuum pump or an air ejector. In some implementations, the pump 110 is adapted for self-priming when it begins operating. Alternatively, a foot or check valve may be used to retain liquid within the pump's 110 suction line. In some implementations, a separate, submersible priming pump is positioned in the aquifer 102 and is operable to prime the pump 110 when it is to be operated.

The pump 110 can be adapted to function in a number of ways, for example, as a rotodynamic pump (e.g., a centrifugal pump) or as a positive displacement pump (e.g., a reciprocating pump). The pump can be powered by any type of prime mover including, for example, an electric motor, a hydraulic motor or even an engine.

In the illustrated implementation, the heat exchanger 106 is positioned just above the earth's surface 116. In other implementations, however, the heat exchanger 106 can be at any elevation. However, generally the heat exchanger 106 is located at an elevation higher than the aquifer 102. In some implementations, the higher elevation may still be subterranean.

In the illustrated implementation, the first and second fluid communication channels 104, 108 are formed from pipes that extend respectively from the inlet and outlet of the heat exchanger 106, down bore holes in the earth and to the aquifer 102. In the illustrated implementation, a respective valve 118a, 118b is provided in each of the first and second fluid communication channels 104, 108. These valves 118a, 118b help to control fluid flow through the channels.

The illustrated implementation also includes a controller 120 which, in various implementations, controls and/or automates various aspects of the system's 100 operations. For example, in some implementations, the controller 120 controls the pump 110, the turbine-generator 112 and/or the valves 118a, 118b. Additionally, in some implementations, the controller 120 receives data from various sensors associated with the system to help automate its functioning. Such sensors can include, for example, fluid level sensors, fluid flow meters, temperature sensors, pressure sensors.

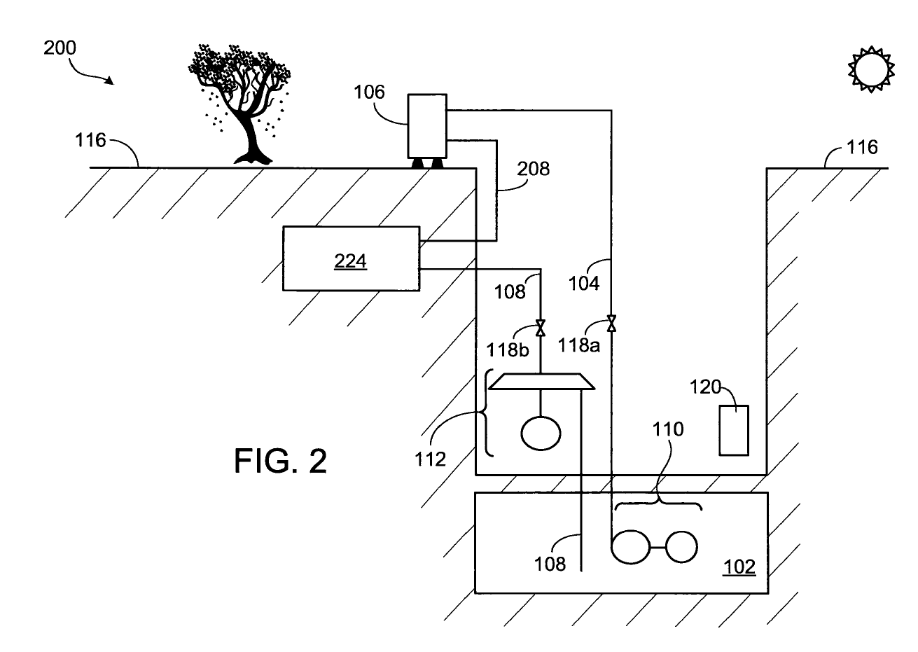

Like the system of FIG. 1, the system 200 of FIG. 2 enables fluid to be taken from a subterranean aquifer 202 and used in connection with a domestic or industrial application in a highly cost-efficient manner. Additionally, the system 200 of FIG. 2 acts as a hydroelectric pumped-storage facility that stores and/or produces energy by moving fluid between two or more aquifers or between an aquifer and some other body of fluid. The energy produced may be used to satisfy demand on an electrical supply system, particularly during periods of relatively high demand. Accordingly, the system 200 of FIG. 2 is particularly cost-efficient.

The illustrated system 200 includes a fluid collection area 224 located above the aquifer 102. The fluid collection area 224 collects and temporarily stores fluid after it has been used (e.g., by heat exchanger 106) for a domestic or industrial purpose, but before it is returned to the aquifer 102. In the illustrated implementation, the fluid collection area 224 is an aquifer. In other implementations, the fluid collection area 224 can be, for example, a man-made or natural body of fluid exposed at the earth's surface 116 (e.g., a lake or reservoir) or any other vessel that can hold fluid.

In some implementations, the illustrated system 200 operates as follows. The pump 110 operates to pump fluid from the aquifer 102 up to heat exchanger 106. The heat exchanger 106 draws heat from the aquifer fluid for use in a domestic or industrial application. Then, the fluid flows into the collection area 224, which in the illustrated implementation is a second aquifer. The fluid may be stored for some time in the collection area 224. At an appropriate time, the fluid may be released (e.g., by opening valve 118b) to flow substantially under the influence of gravity through the turbine-generator 112 and back into the aquifer 102. As the fluid flows through the turbine-generator 112, the turbine-generator converts the fluid's kinetic energy into electrical energy.

The turbine-generator 112 typically is arranged to supply the electrical energy into an electrical supply system (not shown). In some implementations, the release of fluid from the collection area 224 may be timed to coincide with periods of relatively high demand on the electrical supply system. Accordingly, the electrical energy created by the turbine-generator 112 can be used to help satisfy the relatively high demand.

The pump 110 typically is operated by an electrical motor that receives energy from the electrical supply system. In some implementations, the pump's 110 operation is timed to coincide with periods of relatively low demand on the electrical supply system.

Accordingly, it may be desirable for the controller 220 to monitor demand on the electrical supply system. In those instances, if the monitored demand exceeds a predetermined first value, the valve 118b is opened, thereby enabling fluid to flow substantially under the influence of gravity from the collection area 224 to the aquifer 102. During such high demand periods, the pump 110 typically is off and its valve 118a is closed. If, on the other hand, monitored demand drops below a predetermined second value, the pump 110 is turned on and its valve 118a opened so that fluid can move from the aquifer 102 to the means 106 and collection area 224. During such low demand periods, valve 118b may be closed and the turbine-generator 112 may be not operating.

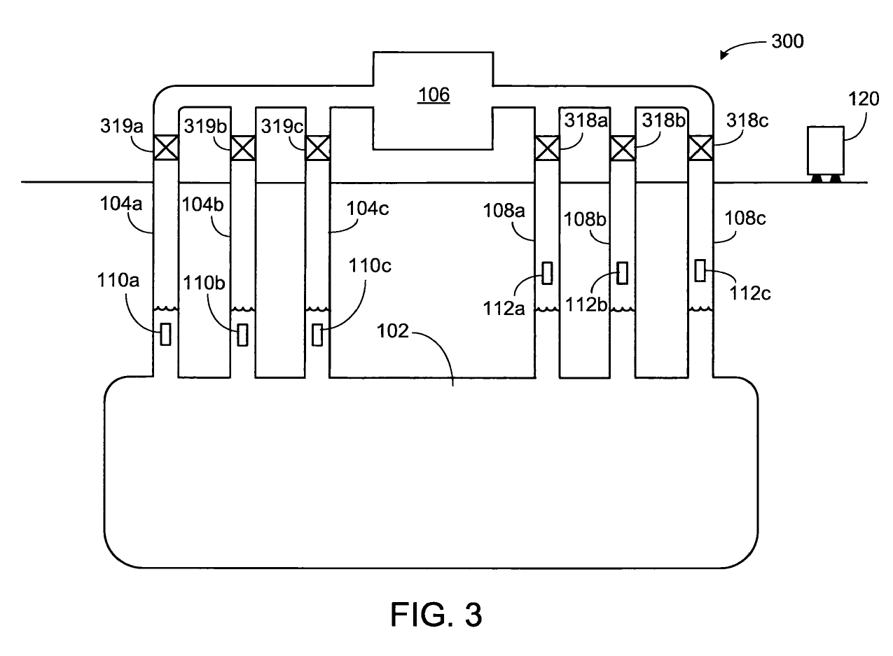

The system 300 illustrated in FIG. 3 is similar in many respects to the system 100 illustrated in FIG. 1. The system 300, however, includes multiple first fluid communication channels 104a, 104b, 104c connected in parallel between the aquifer 102 and the heat exchanger 106. The system 300 in FIG. 3 also includes multiple second fluid communication channels 108a, 108b, 108c connected in parallel between the aquifer 102 and the heat exchanger 106.

A respective pump 110a, 110b, 110c is provided in each of the respective first fluid communication channels 104a, 104b, 104c. Under certain circumstances, it may be desirable to operate more than one of the pumps 110a, 110b, 110c simultaneously. For example, if the demands of the heat exchanger 106 are too high for one pump to satisfy, then more than one pump may be operated.

Each pump 110a, 110b, 110c draws fluid from a different part of the aquifer 102. Accordingly, if one part of the aquifer 102 (e.g., the part that pump 110a draws from) dries up, then another pump (e.g., pump 110b) can be operated to draw from a different part of the aquifer 102.

Check valves 319a, 319b, 319c are provided in each of the respective first fluid communication channels 104a, 104b, 104c. The check valves help to control flow of fluid in those channels and prevent undesirable reverse flow through those channels.

A respective turbine-generator 112a, 112b, 112c is provided in each of the second fluid communication channels 108a, 108b, 108c. Under certain circumstances, it may be desirable to operate more than one of the turbine-generators 112a, 112b, 112c simultaneously. For example, if the supplemental demand on the electrical power supply system is too high for one turbine-generator to satisfy, then more than one turbine-generator can be operated simultaneously.

Valves 318a, 318b, 318c are provided in each respective second fluid communication channel 108a, 108b, 108c and are operable to control fluid flow through each respective channel. Each second fluid communication channel 108a, 108b, 108c returns fluid to a different part of the aquifer 102. If, for example, fluid flow results in one part of the aquifer (e.g., the part that corresponds to second communication channel 108a) becomes overly saturated, then the valve (e.g., valve 318a) that corresponds to that part can be closed and another valve (e.g., valve 318b) can be opened.

A number of embodiments of the invention have been described. Nevertheless, it will be understood that various modifications may be made without departing from the spirit and scope of the invention.

For example, any number of second fluid communication channels may be provided to help provide a sufficient volume of water flowing through the turbine(s). The channels can terminate at different locations in the aquifer so that, for example, if one of the locations becomes too saturated to continue absorbing fluid, it is likely that at least some of the other locations will be able to continue absorbing fluid. Accordingly, a sufficient amount of fluid flow through the fluid communication channel can be sustained to ensure that the turbine-generator continues to operate. Additionally, a second fluid communication channel can include a single pipe that extends from the heat exchanger down to the turbine-generator, with multiple pipes extending from the turbine-generator to different parts of the aquifer.

Similarly, any number of first fluid communication channels may be provided to help provide a sufficient volume of water being drawn out of the aquifer. The channels can terminate at different locations in the aquifer so that, for example, if one of the locations becomes too dry to continue providing fluid, it is likely that at least some of the other locations will be able to continue providing fluid. Additionally, a first fluid communication channel can include a single pipe that extends from the heat exchanger down to a single pump, with multiple pipes extending from the pump to different parts of the aquifer.

As another example, a hydroelectric pumped storage facility can be adapted to move fluid between three or more aquifers in order to store and/or release energy.

The techniques disclosed herein can be implemented with various types of aquifers including, for example, saturated and unsaturated aquifers, as well as confined and unconfined aquifers. One or more of the aquifers can be man-made. Multiple fluid communication channels can be connected to a single turbine-generator and/or to a single pump to enable movement of greater amounts of fluid. Determining when to move fluid from one aquifer to another may be influenced by a wide variety of considerations. For example, fluid may be moved from an aquifer to a means for using the fluid at a higher elevation during the night and from the means to the aquifer during the day.

Additionally, the bore holes that house some of the components disclosed herein can have different sizes and shapes. Some components including, for example, parts of the fluid communication channel(s) can be located above ground. Some implementations include multiple pumps and/or multiple turbines associated with a single fluid communication channel. The valves in the fluid communication channels can be configured in a variety of ways. Multiple valves can be situated at different sections in each fluid communication channel.

Moreover, the generator can be adapted to synchronize and connect to an associated electrical supply system in a variety of ways. In some implementations, synchronization and connection is automated and controlled, for example, by the controller. Any type of generator can be utilized as well. However, the generator's prime mover should be operable in response to flowing fluid.

The aquifer fluid can be used for any type of domestic or industrial application. Such uses include heating, cooling, and use in connection with turbine systems, including binary turbines, to create electricity. The phrase “domestic or industrial application” as used herein includes any use that aquifer fluid may be put to. The phrase “turbine-generator” includes any component or combination of components capable of converting kinetic or potential energy of a fluid into electrical energy.

In some implementations, the pump and the turbine-generator can be combined into a single housing as a reversible pump-turbine. In that situation, the reversible pump-turbine would be capable of operating as a pump to move fluid from the aquifer to the heat exchanger (or other means for using the aquifer fluid) and would be capable of operating as a turbine-generator to convert kinetic energy of fluid flowing from the heat exchanger to the aquifer into electrical energy. The reversible pump-turbine can be positioned sufficiently above the aquifer's fluid level to ensure adequate flow when operated in turbine-generator mode. Priming provisions may be required to ensure that the pump is primed prior to operating in pump mode.

Accordingly, other implementations are within the scope of the claims.

What is claimed is:

1. A method comprising:
moving fluid from an aquifer to a higher elevation;
using the fluid at the higher elevation for a domestic or industrial application;
after using the fluid for the domestic or industrial application, enabling the fluid to return from the higher elevation to the aquifer; and
converting kinetic energy of the fluid returning to the aquifer into electrical energy.

2. The method of claim 1 wherein converting the kinetic energy of the fluid returning to the aquifer comprises directing the fluid through a turbine-generator.

3. The method of claim 2 wherein the turbine-generator is located a sufficient height above the aquifer's fluid level that the fluid returning to the aquifer can flow substantially freely through the turbine-generator.

4. The method of claim 1 wherein moving the fluid from the aquifer to the higher elevation comprises pumping the fluid with a submersible pump located beneath the aquifer's fluid level.

5. The method of claim 1 wherein using the fluid comprises removing heat from the fluid.

6. The method of claim 1 wherein using the moved fluid comprises using the fluid as a heat sink.

7. The method of claim 1 wherein the fluid is moved from the aquifer to the higher elevation through a first fluid communication channel and returned to the aquifer through a second fluid communication channel.

8. The method of claim 1 wherein the fluid enters a collection area at the higher elevation before returning to the aquifer.

9. The method of claim 8 further comprising:
using electrical energy from an electrical supply system to move the fluid from the aquifer to the higher elevation; and
supplying electrical energy to the electrical supply system from the turbine-generator;
monitoring demand on the electrical supply system;
if the monitored demand exceeds a predetermined first value, allowing fluid to flow from the higher elevation to the aquifer; and
if the monitored demand is less than a predetermined second value, preventing at least some of the fluid from exiting the collection area to return to the aquifer.

10. A system comprising:
an aquifer;
a pump to move fluid from the aquifer to a higher elevation;
means at the higher elevation to use the moved fluid for a domestic or industrial purpose; and
a turbine-generator to convert kinetic energy of fluid that is returned to the aquifer substantially under the influence of gravity into electrical energy.

11. The system of claim 10 wherein the turbine-generator is located a sufficient height above the aquifer's fluid level that the fluid returning to the aquifer can flow substantially freely through the turbine-generator.

12. The system of claim 10 further comprising:
a first fluid communication channel between the aquifer and the higher elevation, through which the pump can move fluid; and
a second fluid communication channel between the aquifer and the higher elevation to facilitate the fluid's return to the aquifer from the higher elevation.

13. The system of claim 12 wherein a portion of the second fluid communication channel that extends between the turbine-generator and the aquifer comprises multiple paths that terminate at different places in the aquifer.

14. The system of claim 10 wherein the pump is a submersible pump and is located beneath the aquifer's fluid level.

15. The system of claim 10 wherein the means to use the moved fluid for a domestic or industrial purpose comprises a heat exchanger.

16. The system of claim 10 wherein the means to use the moved fluid for a domestic or industrial purpose comprises a fluid heat sink, which is replenished by the fluid moved from the aquifer.

17. The system of claim 10 further comprising:
a collection area at the higher elevation where the fluid can be collected before returning to the aquifer.

18. The system of claim 17 further comprising:
an electrical supply system to supply energy to move the fluid from the aquifer to the higher elevation,
wherein the turbine-generator supplies electrical energy to the electrical supply system; and
a control system to:
monitor demand on the electrical supply system;
if the monitored demand exceeds a predetermined first value, allow fluid to flow from the collection area to the aquifer; and
if the monitored demand is less than a predetermined second value, prevent at least some of the fluid from exiting the collection area and returning to the aquifer.

19. A method comprising:
monitoring demand on an electrical supply system;
if the monitored demand exceeds a predetermined first value:
enabling fluid to flow substantially under the influence of gravity from an elevation above an aquifer into the aquifer; and
converting kinetic energy associated with the flowing fluid into electrical energy; and
if the monitored demand drops below a predetermined second value:
moving fluid from the aquifer to the elevation; and
when the fluid is at or near the elevation above the aquifer, using the fluid for a domestic or industrial application.

20. The method of claim 19 wherein converting the kinetic energy of the flowing fluid into electrical energy comprises causing the fluid to flow through a turbine-generator.

21. The method of claim 20 wherein the turbine-generator is located a sufficient distance above the second aquifer's fluid line that the fluid flows freely through the turbine-generator.

22. A system comprising:
a first aquifer;
a second aquifer;
one or more fluid communication channels that facilitate fluid flow between the first and second aquifers;
a turbine-generator to convert kinetic energy of fluid flowing from the first aquifer to the second aquifer through one or more of the fluid communication channels into electrical energy;
a pump to move fluid from the second aquifer to the first aquifer; and
a heat exchanger to remove heat from or deposit heat to the fluid as the fluid is moved from the second aquifer to the first aquifer in connection with a domestic or industrial application,
wherein the turbine-generator is positioned a sufficient distance above the second aquifer that the fluid flowing from the first aquifer to the second aquifer can flow freely through the turbine-generator.
